(19) United States
(12) Patent Application Publication
(10) Pub. No.: US 2006/0023020 A1
(43) Pub. Date: Feb. 2, 2006

(54) Head cleaning member for ink jet printer

(75) Inventors: Jiro Hattori, Atsugi-city (JP); Koichi Sano, Sagamihara-city (JP)

Correspondence Address: 3M INNOVATIVE PROPERTIES COMPANY, PO BOX 33427, ST. PAUL, MN, 55133-3427, US

(73) Assignee: 3M Innovative Properties Company, St. Paul, MN (US)

(21) Appl. No.: 10/532,786

(22) PCT Filed: Oct. 20, 2003
(86) PCT No.: PCT/US03/33334

§ 371 Date: Apr. 25, 2005

(30) Foreign Application Priority Data
Nov. 29, 2002 (JP) 2002-347424

(51) Int. Cl. B41J 2/165

(52) U.S. Cl. 347/33

(57) ABSTRACT

To provide a head cleaning device for ink jet printers, which permits refresh operation of the recording head to be performed easily and quickly, and which has simple and compact structure. A head cleaning device which is used in an inkjet printer between a recording head and a recording medium has a major surface that is equal to or greater than an ink ejection surface of the recording head, and is constructed such that it comprises, on said major surface, a head cleaning member having a multiplicity of parallel and fine ink discharging grooves so as to permit waste ink to flow in a definite direction.

### FIELD OF THE INVENTION

The present invention relates to an improvement of an ink jet printer, and more particularly to a head cleaning device, which is used in an ink jet printer having a recording head for printing on a recording medium by ejecting ink and which is disposed between the recording head and the recording medium and used for refreshment of the recording head and recovery of waste ink. In particular, the present invention relates to a head cleaning member that is useful for the construction of the head cleaning device.

### BACKGROUND

As is well known, an ink jet printer is widely used as a recording apparatus such as a printer, a copying machine, and a facsimile, or as an output device for an electronic equipment such as a computer, word processor, etc. An ink jet printer which performs printing on a recording medium by ejecting ink from a recording head, has several advantages, for example, it has a compact recording head, permits high speed printing and color printing to be carried out easily, allows various recording medium including an ordinary paper to be used, requires low running cost, and generates less amount of noise in operation, etc.

In an ink jet printer, a printing method is adopted in which ink is supplied from nozzles of a recording head, and ejected in the form of ink droplets from the nozzle hole (ink ejection port) provided at the tip of the recording head, the printing performance depends heavily on the condition of the nozzle hole or the ink ejection port. Therefore, it is a general practice to provide the inkjet printer with a head cleaning device. Also, for preventing the nozzles from being clogged with ink, it is an ordinary practice to perform an empty ejection of ink (refresh operation) at a regular interval, to cover the circumference of the ink ejection port with a cap, or to wipe off the ink residues which adheres to the circumference of the ink ejection port with a wiper such as an elastic blade. For example, a head wiping method for wiping off ink from a head of an ink jet printer, comprising the steps of admitting ink through the print head nozzles, dissolving the accumulated ink residue adjacent to the nozzles with the admitted ink, and wiping off the admitted ink and the dissolved ink residue from the head using a wiper mounted to the chassis of the printing mechanism is known (Patent Literatures 1 and 2). Also, an ink jet printer comprising a cap which covers the ink ejection port of the recording head when not in use, an elastic blade for wiping the ejection port surface of the recording head, an ink recovery tub for receiving ink ejected from the head in refresh operation and having the cap mounted to the opening portion thereof and a scattering protection wall means for collecting the ink droplet scattered by the elastic blade is known (Patent Literature 3).

However, there are some important problems associated with the prior art ink jet printer and its head cleaning device. For example, although more compact design is increasingly required for an ink jet printer, conventional cleaning device which adopts complicated construction poses a limit to this trend for more compact design. Also, although some cleaning effect may be expected from conventional device, there are problems associated with conventional device, such as excessive time required for processing, inability to completely absorb and recover the ink residue, etc.

More importantly, conventional head cleaning device is designed for an ink jet printer with a movable recording head wherein an empty ejection of ink (refresh operation) in a stand-by position is possible. In recent ink jet printer for color printing, however, where a fixed recording head is often adopted, conventional head cleaning device cannot be used as it is. Thus, with a printer having a fixed head, refresh operation is required for each head of ink corresponding to each of the colors (cyan, magenta, yellow, black, etc.). Therefore, the construction of the head cleaning device becomes complicated, and sufficient space for mechanism is required in order to avoid interference with the head, which hinders improvement of the printing speed.

### SUMMARY

It is an object of the present invention to provide a head cleaning member which is to be used with an ink jet printer and which permits refresh operation of the recording head to be performed easily and quickly, and has a simple and compact construction.

It is another object of the present invention to provide a head cleaning member that can be advantageously used with an ink jet printer having a fixed recording head.

It is still another object of the present invention to a head cleaning device incorporating the head cleaning member of the present invention.

It is an object of the present invention to provide a head cleaning member which is to be used with an ink jet printer and which permits refresh operation of the recording head to be performed easily and quickly, and has a simple and compact construction.

It is another object of the present invention to provide a head cleaning member that can be advantageously used with an ink jet printer having a fixed recording head.

It is still another object of the present invention to a head cleaning device incorporating the head cleaning member of the present invention.

According to the present invention, there is provided a head cleaning member which is used in an ink jet printer that performs printing on a recording medium by ejecting ink from a recording head, and is abutted when in use against an ink ejection surface of the recording head, in which the head cleaning member has a major surface having an area equal to or larger than the ink ejection surface of the recording head and a multiplicity of parallel and fine ink discharging grooves are provided on the major surface such that waste ink can flow in a definite direction.

According to the present invention, there is also provided a head cleaning device which is used in an ink jet printer having a recording head that ejects ink for printing on a recording medium and which is disposed in use between the recording head and the recording medium, comprising a head cleaning member which has a major surface having an area equal to or larger than the ink ejection surface of the recording head and wherein a multiplicity of parallel and fine ink discharging grooves are provided on the major surface of the head cleaning member such that waste ink can flow in a definite direction.

There is further provided, in accordance with the present invention, an ink jet printer comprising a fixed recording head which ejects ink for printing on a recording medium, and a head cleaning device according to the present invention disposed between the recording head and the recording medium.

### BRIEF DESCRIPTION OF THE DRAWINGS

FIG. 1 is a perspective view showing a head cleaning device according to a preferred embodiment of the present invention.

FIG. 2 is a sectional view taken along the line II-II of the head cleaning device shown in FIG. 1.

FIG. 3 is a perspective view showing a head cleaning device according to another preferred embodiment of the present invention.

FIG. 4 is a perspective view showing a head cleaning device according to still another preferred embodiment of the present invention.

FIG. 5 is a sectional view showing a head cleaning member according to another preferred embodiment of the present invention.

FIG. 6 is a sectional view showing the operation of the head cleaning member shown in FIG. 5.

FIG. 7 is a sectional view showing the operation of the head cleaning member shown in FIG. 5.

FIG. 8 is a sectional view showing a head cleaning member according to still another preferred embodiment of the present invention.

### DETAILED DESCRIPTION

The present invention resides in a head cleaning device and a head cleaning member for an ink jet printer, and an ink jet printer.

Basically, the present invention can be applied to any type of ink jet printers. Thus, the ink jet printers according to the present invention include recording apparatus such as printers, copying machines, and facsimiles, and recording devices widely used as output devices of electronic equipments such as computers, word processors. Thus, an ink jet printer usually comprises an ink cartridge containing ink, a recording medium conveying mechanism for conveying a record medium to a printing position, and after printing to a non-printing position, and a recording head consisting of an orifice plate having a plurality of nozzles, and the like. There are several types of recording head, including a piezoelectric type which utilizes an electromechanical converter such as a piezoelectric device for ejecting ink droplets from the tip of the nozzles by reduction of the volume of the ink room, a thermal type which utilizes irradiation of electromagnetic wave such as laser radiation for ejecting ink droplets from the tip of the nozzles by the action of generated heat, or utilizes a heating resistor to heat ink and thereby eject ink droplets, etc. Moreover, with an ink jet printer, the restriction on the type of recording medium is eliminated, and printing can be performed successfully on different papers including ordinary paper and plastic films, fabrics, felts, leather, metal, or the like. On specific details of an ink jet printer, reference is made to Patent Publications cited above and other patent documents and technical books.

In such an ink jet printer of various types, the head cleaning device of the present invention is intended to be disposed between a recording medium and a recording head which ejects ink for printing on the recording medium in order to refresh the head and collect the waste ink generated in the refresh operation. Such a head cleaning device is compact and of high performance so that it produces remarkable operative effect when applied to an ink jet printer with fixed recording head for color printing which is widely used recently. Since, in this type of ink jet printers, refresh operation cannot be performed with the recording head moved to the stand-by position, the compact and high performance head cleaning device of the present invention fully exhibits its advantageous effects.

Next, the head cleaning device and head cleaning member of the present invention will be described in detail with reference to appended drawings showing preferred embodiments thereof. It is to be understood that the present invention is not limited to the embodiments described below, and various modifications and improvements can be made within the scope of the present invention.

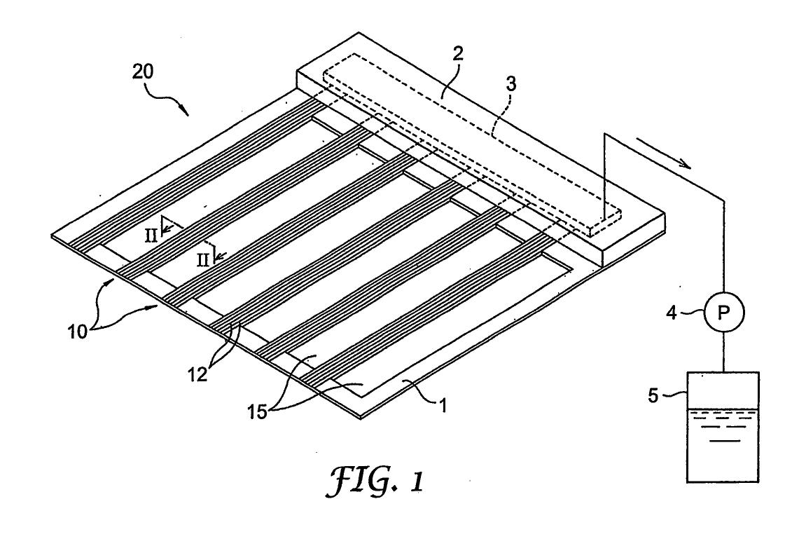

FIG. 1 is a perspective view showing a head cleaning device according to a preferred embodiment of the present invention. The head cleaning device 20 is used as disposed in front of a plurality of unshown recording heads (six heads in this instance) that perform printing on a recording medium by ejecting ink of different colors from the tip of respective built-in nozzles, that is, as disposed in the space between the recording heads and the recording medium.

The head cleaning device 20 is comprised of a movable plate 1, and a film-like head cleaning member 10 applied to the side on the recording head thereof. The cleaning member 10 includes the same number of cleaning zones as the number of recording heads, each zone having a group of ink discharging grooves. Thus, in this instance, six cleaning zones are included.

The movable plate 1 includes openings 15 having approximately the same width as the width of the respective recording heads so as not to interfere with the flight of ink droplets from the recording heads while printing, and the cleaning member 10 is applied to the portion of the movable plate defining adjoining openings 15. This portion having the head cleaning member 10 applied thereto and having a group of ink discharging grooves is the “cleaning zone” referred to in the present invention. The movable plate 1 can be moved in front of the plurality of recording heads, parallel to the ink ejection surface, that is, in the horizontal direction such that a shutter mechanism may be realized between heads of adjoining colors. Thus, the movable plate 1 can be moved to realize the same effect as a shutter in such a manner that the openings 15 face the heads so as not to interfere with the flight of ink droplets when printing, whereas the head cleaning member 10 faces the heads when standing-by (when not printing). With such a shutter mechanism, duration of empty ejection of ink in refresh operation can be reduced.

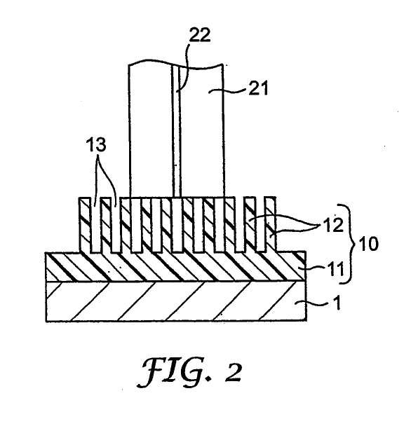

The construction of the head cleaning member 10 can be easily understood from FIG. 2 which is a cross sectional view taken along the line II-II of the head cleaning member 10 shown in FIG. 1.

The movable plate 1 may have, in each cleaning zone, approximately the same width as the head cleaning member 10. Material for the movable plate 1 is not particularly limited, and it is preferably formed of light weight material with high mechanical strength and excellent anti-corrosion property. Suitable material includes various plastic material such as polycarbonate, polypropylene, and metals such as aluminum and its alloys, and the like.

The head cleaning member 10 may have various size and shape, and first of all, the respective cleaning zone needs to have major surface of a width at least sufficient to cover the ink ejection surface (surface in which the nozzle 22 terminates to form ink ejection port) of the recording head. If the width of the ink receiving surface of the head cleaning member 10 is less than that of the ink ejection surface, ink may not be completely recovered in refresh operation, or ink residue or other dust particles adhering to the ink ejection surface may not be removed completely. The width of the ink receiving surface of the head cleaning member 10 may be varied arbitrarily depending on the ink ejection surface of the recording head. The width is typically about 2 to 10 mm. In general, the width of about 5 mm is sufficient to receive waste ink for recovery. The width of the ink receiving surface needs not be unnecessarily large since this would go against the trend for more compact design of an ink jet printer. Also, in general, the width of the opening defined by adjacent cleaning zones is preferably the same as the width of the cleaning zone.

Although the thickness of the cleaning member 10 may be varied widely, when it takes the form of an ink guiding film as shown in the figure, the thickness is typically in the range of about 50 μm to 5 mm, preferably in the range of about 100 μm to 2 mm. In general, the adequate thickness of the ink guiding film including the thickness of the base body such as the movable plate that supports the film may be about 3 mm or less, and this can contribute greatly to miniaturization and more compact design of the head cleaning device and the ink jet printer.

As regards the shape of the head cleaning member 10, basic requirement is that a multiplicity of parallel and fine ink discharging grooves 13 be provided on the major surface thereof. Each ink discharging groove 13 is defined by small ridge-like projections 12 of about same height arranged at approximately the same interval (pitch) and in parallel 10 with each other. In the illustrated instance, all small projections 12 are formed on the base body 11 integrally with it.

The cross sectional shape (section when cut in transverse direction) of the ink discharging grooves 13 may be varied depending on the size of the recording head or the composition of ink. Suitable shape of the cross section includes, but is not limited to, U-shape, V-shape, rectangle and the like. Two or more different shapes may be combined, if necessary. With any cross sectional shape adopted, waste ink generated in refresh operation can be recovered completely together with ink residue and other dust at the ink ejection port.

The size of the cross section of the ink discharging groove 13 is, assuming that the cross section is of rectangular shape as shown in FIG. 2, typically about 3000 μm or less in width and about 50 to 3000 μm in height, preferably about 1500 μm or less in width and about 100 to 1000 μm in height. If the width of the ink discharging groove 13 is wider than 3000 μm, there may arise a problem in absorption of liquid. Likewise, if the height of the ink discharging groove 13 is less than 50 μm, capillary action of the ink discharging grooves 13 is adversely affected and adequate speed cannot be obtained for the absorption of desired quantity of liquid. On the other hand, if the height exceeds 3000 μm, the ink discharging groove 13 becomes too thick, giving rise to the inconvenience that the film becomes too hard.

The size of the ridge-like projection 12 which defines the ink discharging groove 13 may also be varied arbitrarily in accordance with the size of the ink discharging groove 13. The size of the ridge-like projection 12 is typically 20% or less of the width of the ink discharging groove 13 in width and 0.5 to 80% of the height of the ink discharging groove 13 in height, preferably 10% or less of the width of the ink discharging groove 13 in width and 5 to 50% of the height of the ink discharging groove 13 in height.

The ink discharging groove 13 may be formed from various materials, and is preferably formed by molding of plastic material. Suitable plastic material for molding includes, but is not limited to, thermoplastic materials, for example, polyolefin such as polypropylene, polyester, polyamide, polyimide, polyvinyl chloride, polyether ester, polyester amide, polyacrylate, polyvinyl acetate, and combination thereof, and thermosetting materials, for example, polyurethanes, acrylates, epoxy resins, silicone resins, etc.

Molding method using these plastic materials includes, for example, injection molding method, emboss processing, etc. Molding method using cross-linking type polymer materials such as polyurethanes, acrylates, epoxy resins, silicone resins, includes casting process utilizing cross-linking reaction by means of ultraviolet radiation, electron beam, moistures, etc. In order to control surface tension of these polymer materials, hydrophilic or hydrophobic additives may be mixed or coated to these polymer materials. In general, polyolefm can be advantageously used because of its good transferrability for precise shape of groove and mechanical properties. In particular, polyethylene added with 0.1 to 0.5% by weight of hydrophilic additives, for example, TRITON X-100 available from Union Carbide Co. (octylphenoxypolyethoxyethanol nonionic surface active agent) is suitable. Especially good head cleaning member 10 which is suitable for the purpose of the invention, and which has excellent property for the flow of waste ink can be obtained by using an ultrafine replication method according to the applicant of the present invention. The ultrafme replication method is disclosed in a PCT international patent publication No. WO 00/42958.

The head cleaning member 10 may be used with no surface treatment of its surface, especially the surface of the ink discharging grooves 13. In order to achieve smoother flow of waste ink, however, surface treatment for obtaining ink repellent surface or the like may be performed. Suitable ink repellent treatment includes, for example, fluorination treatment.

In the illustrated head cleaning device 20, a waste ink recovery case 2 having a waste ink sump 3 which collects waste ink after flowing through the ink discharging grooves 13 is provided together with a waste ink recovery unit which is in communication with the waste ink sump 3 for extracting and recovering the waste ink. The waste ink recovery unit adopted in this embodiment consists in a combination of a suction pump 4 and a waste ink tank 5. Recovery of waste ink is performed, for example, as follows.

At the time of refresh operation of the recording head 21, ink is ejected from its nozzles, and waste ink is received by a closed space defined by the ink discharging grooves 13 and the head 21 abutting against the head cleaning member 10. Together with the waste ink, ink residue adhering to the circumference of the ink ejection port of the head 21 and minute paper debris or other dust are also received by this space. In such a state, by applying vacuum with the suction pump 4, the waste ink in the ink discharging grooves 13 is fed from the ink discharging grooves 13 via the waste ink sump 3 in the waste ink recovery case 2 to the waste ink tank 5, and is recovered there.

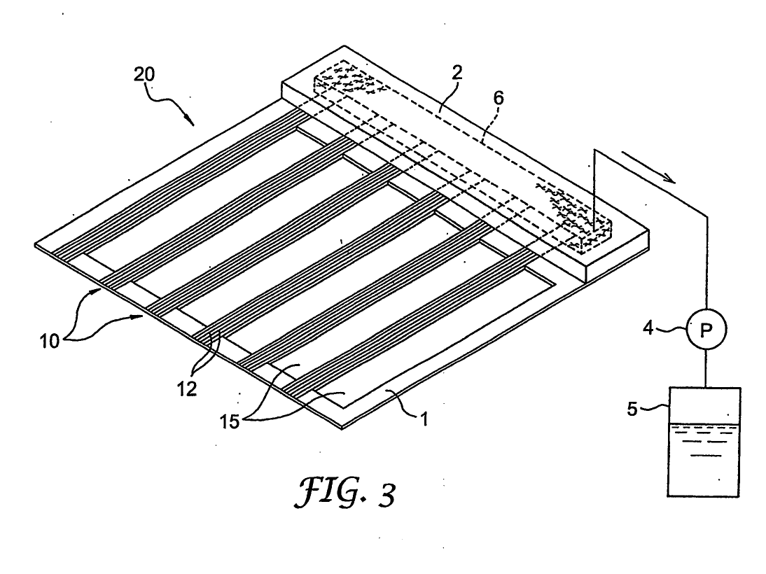

Although, in the embodiment shown in FIG. 1, the waste ink sump 3 is a simple space having no filler in it, the space may be filled with a waste ink absorbent 6, as shown in FIG. 3. Examples of the waste ink absorbent 6 include, but are not limited to, various fiber materials such as a felt using waste fiber material, porous plastic films such as a sponge of urethane foam, and the like. In particular, polymer absorbent materials such as is used in disposable diapers, for example, cross-linking polyacrylate resins, can be advantageously used. The efficiency of recovering waste ink can be increased drastically by the presence of the waste ink absorbent 6. This method is suitable especially when total amount of waste ink is small or when exchange of the waste ink absorbent is presupposed.

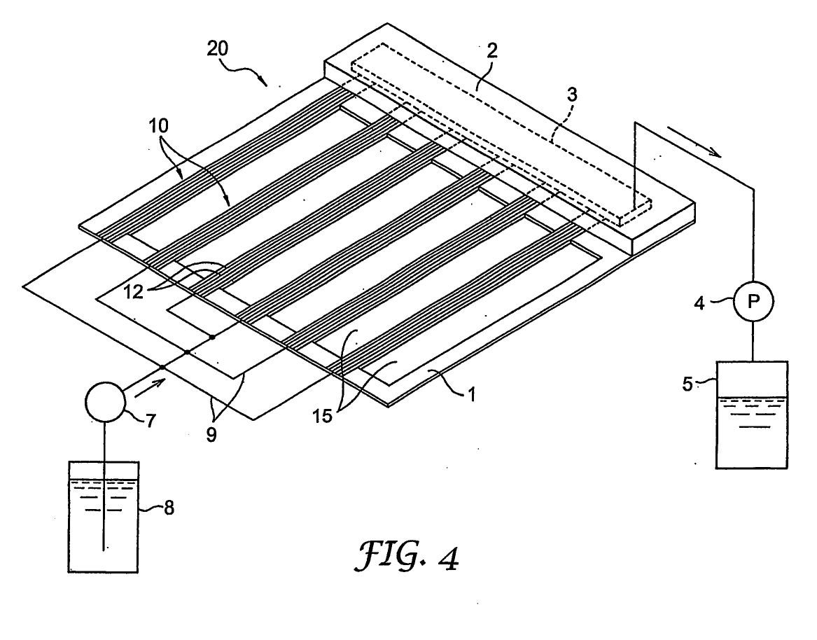

The head cleaning device of the present invention may be constructed such that a cleaning solution supplying unit is further provided on the upstream side of the ink discharging grooves for holding cleaning solution to wash the ink discharging grooves, and supplying at the time of refresh operation necessary amount of the cleaning solution to the ink discharging grooves. FIG. 4 is a schematic view showing such a head cleaning device 20. The basic construction is the same as has been described with reference to FIG. 1. However, the head cleaning device 20 is further provided with a cleaning solution supplying unit including a cleaning solution tank 8 and a pressure feed pump 7. In the cleaning solution tank 8, cleaning solution such as water or alcohol is provided beforehand. The cleaning solution is sucked by the pressure feed pump 7, and fed via distributing pipe 9 to respective ink discharging grooves 13 at high pressure. The cleaning solution is, after taking in the waste ink and ink residue accumulated in the ink discharging grooves 13, recovered via the waste ink sump 3 and the suction pump 4 to the waste ink tank 5. This embodiment is suitable to the present invention since the cleaning of the ink discharging grooves is done simultaneously with the recovery of the waste ink.

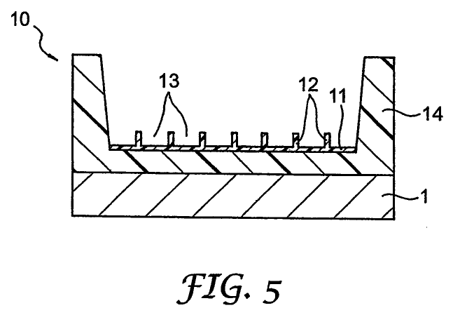

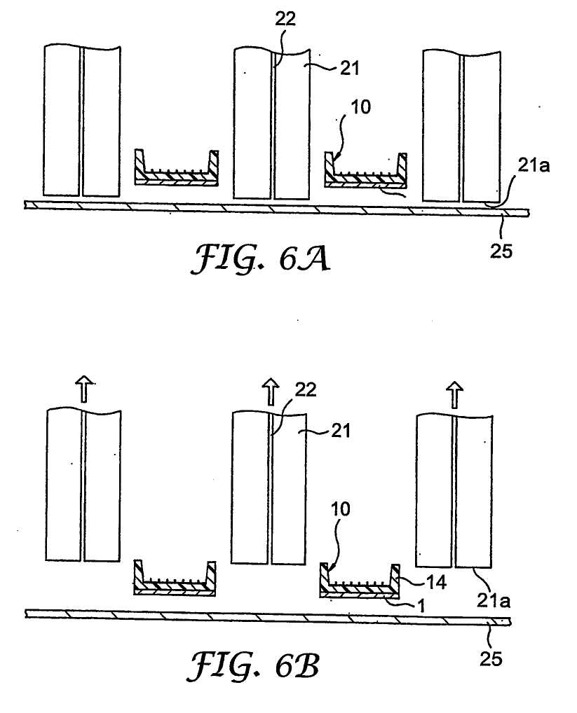

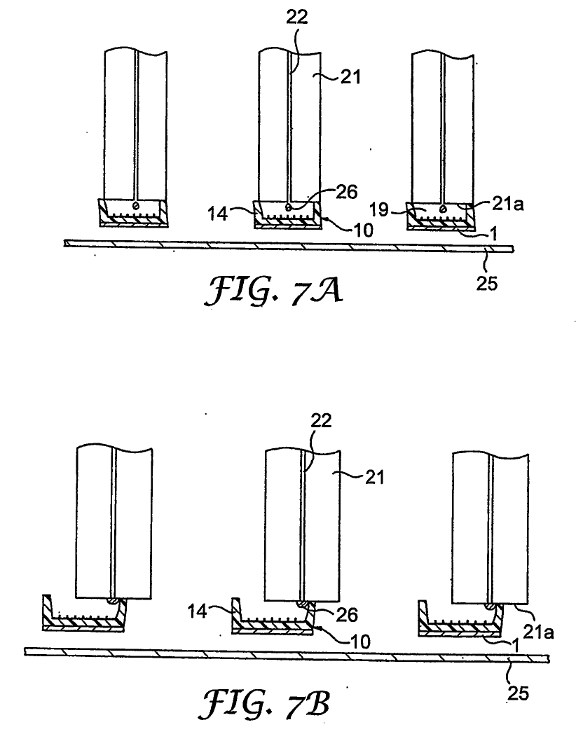

The head cleaning member of the present invention may be constructed such that it further comprises, at both end portions thereof, a side wall extending in the longitudinal direction and rising up to a height greater than the ridge-like projections that define the ink discharging grooves. FIG. 5 is a schematic view showing such a head cleaning member 10, wherein a side wall member 14 is joined to the movable plate 1 with an adhesive such that a side wall rises up vertically at both ends, and a waste ink guiding film, that is, a base body 11 with ridge-like projections 12 is adhered to the concave portion surrounded by the side wall at both ends. With such a construction, as described below with reference to FIGS. 6 and 7, it becomes possible, in addition to the recovery of waste ink, to scrape off ink residue or other solid precipitates such as dust particles adhering to the ink ejection surface by contacting the ink ejection surface of the recording head with the side wall at both ends of the head cleaning member 10.

A head cleaning member in which the ink discharging grooves have the form of a ink guiding film and the ink guiding film is applied and adhered to the base, for example the movable plate or the side wall member, with an adhesive, has been described with reference to FIGS. 2 and 5. However, instead of employing such a form of ink circulation film, the present invention may be constructed such that the ink discharging grooves are formed integrally with the major surface of the base body of the head cleaning member, the movable plate and the side wall member. The head cleaning member having such an integral structure may be fabricated, as in the case of the fabrication of above described film-shaped head cleaning member, from various thermoplastic materials. The integral head cleaning member can be preferably fabricated from elastomers such as urethane resins or polyester resins by any of usual molding methods known to those skilled in the art.

FIGS. 6 and 7 are views showing actual steps of usage of the head cleaning member shown in FIG. 5 in sequential order.

When the ink jet printer is used in printing, the recording head 21 including the nozzle 22 is, as shown in FIG. 6(A), in the proximity of the recording medium (here, recording paper) 25. The separation between the ink ejection surface 21a of the head 21 and the recording paper 25 is about 1 μm. The openings of the movable plate 1 are wider than the width of the ink ejection surface 21 a of the head 21 so that there is no problem for the ejection of ink droplets from the nozzle 22.

Next, for refresh operation, as shown in FIG. 6(B), the head 21 is raised in the direction of arrows. When the height of the ink ejection surface 21a of the head 21 becomes approximately equal to the height of the side wall member 14 provided at both ends of the head cleaning member 10, the rise of the head 21 is stopped.

Then, as shown in FIG. 7(C), the movable plate 1 holding the head cleaning member 10 is moved to right until the ink ejection surface 21a of the head 21 is completely sealed by the side wall member 14 of the head cleaning member 10 so as to form a closed space 19. In this state, empty ejection of an ink droplet 26 for refreshment is performed to wash the interior of the nozzle 21 and the ink ejection surface 21a. Waste ink thus generated containing ink residue and fine dust is pressure-fed to the waste ink tank by application of vacuum to the space 19 using, for example, a suction pump, and is recovered there.

After completion of the refresh operation, as shown in FIG. 7(D), the used head cleaning member 10 (movable plate 1) is moved to left and returned to the original stand-by position. In so doing, ink residue or the like 27 adhering to the ink ejection surface 21a of the head 21, if any, is scraped off by the tip of the side wall member 14 pressed tightly against the ink ejection surface 21a, and collected into the space 19. The collected ink residue or the like 27 is washed at the time of next refresh operation and recovered by the waste ink tank.

As can be understood from the above explanation, the head cleaning member 10 according to the present invention functions like a shutter when the movable plate 1 holding it is moved left and right, and refresh operation can be carried out by simply moving the head cleaning member 10 up and down by a small distance. Refresh operation per se can also be done easily and quickly.

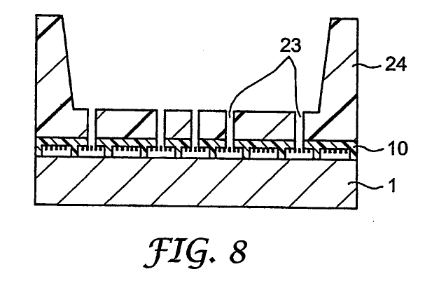

FIG. 8 is a perspective view showing a head cleaning member according to still another preferred embodiment of the present invention. As shown in the figure, after the head cleaning member 10 of the present invention in the form of a ink guiding film is disposed on the movable plate 1, a rib-shaped waste ink receiving member 24 formed by molding of an elastomer material is further applied and adhered to it. The waste ink receiving member 24 has communicating holes 23 for feeding waste ink to the ink guiding film. Both ends of waste ink receiving member 24 constitute side walls rising up in the same manner as the side wall member 14 of the head cleaning member 10 described above with reference to FIG. 5.

When the head cleaning member 10 constructed as shown in the figure is used in refresh operation of the recording head, the same operative effect can be obtained as in the case of the head cleaning member 10 described above with reference to FIGS. 6 and 7.

First, the ink ejection surface of the head is completely sealed by the side wall of the waste ink receiving member 24 disposed on the head cleaning member 10 so as to form a closed space so that, when empty ejection of ink droplets for refreshment from the nozzles of the head is performed, waste ink including ink residue and fine dust particles can be completely recovered with no leakage to outside. Since the side wall at both ends of the waste ink receiving member 24 can be brought into contact with the ink ejection surface of the head, it is possible to scrape off the solid precipitates such as ink residue adhering to the ink ejection surface. Further, since the waste ink receiving member 24 is provided with the communicating holes 23, waste ink which has dropped from the nozzle hole of the head and which is received by the waste ink receiving member 24 can be effectively transferred to the underlying head cleaning member (ink circulation film) 10. Also, since a closed space is formed in the head cleaning member 10 by its partition walls, waste ink confined in the closed space can be sucked by a suction pump, and can be quickly and easily recovered via the waste ink sump to the waste ink tank.

As has been described in detail above, in accordance with the present invention, a head cleaning device for an ink jet printer is provided wherein refresh operation of the recording head can be performed easily and quickly, and structure is simple and compact.

In the ink discharging grooves of the head cleaning member, a capillary phenomenon manifests itself so that the waste ink which has been used in refresh operation can be efficiently circulated in the discharging direction and recovered to the waste ink tank or the like.

The head cleaning device of the present invention realizes a shutter with its head cleaning member, and thereby can be advantageously used in a fixed-head type ink jet printer. In particular, refresh operation and removal of ink residue and the like can be performed simultaneously simply by slight displacement of the head cleaning member between heads provided for various colors, so that required time for refresh operation can be drastically reduced.

Further, in accordance with the present invention, by providing absorbent for waste ink and suction recovery mechanism in the waste ink recovery system, it is possible to recover waste ink over a long time period. Also, by providing a cleaning solution supplying mechanism on the upstream side of the ink discharging grooves, maintenance of the head cleaning member can be more easily done.

Furthermore, in accordance with the present invention, a head cleaning member useful for the construction of the head cleaning device can be provided. In particular, the head cleaning member may be constructed in the form of film or may be formed as a member having ink discharging grooves of similar depth, and thereby can contribute greatly to the development toward smaller an more compact head cleaning device and ink jet printer. Since waste ink received by a multiplicity of parallel ink discharging grooves needs to be conveyed only in the direction of the grooves, width of about 5 mm corresponding to the width of the recording head is sufficient for one cleaning band zone to recover waste ink without contaminating the recording medium, printer or other mechanism.

What is claimed is:

1. A head cleaning member for use with an ink jet printer that performs printing on a recording medium by ejecting ink from a recording head, said cleaning member being used in abutment against an ink ejection surface of the recording head, in which
said head cleaning member has a major surface having an area equal to or larger than the ink ejection surface of said recording head and
a multiplicity of parallel and fine ink discharging grooves are provided on said major surface such that waste ink can flow in a definite direction.

2. A head cleaning member according to claim 1, wherein said ink discharging grooves are integrally formed on the major surface of a base body of said head cleaning member.

3. A head cleaning member according to claim 1, wherein said ink discharging grooves are formed on a surface of a waste ink guiding film adhered to a base body of said head cleaning member.

4. A head cleaning member according to any one of claims 1 to 3, wherein said ink discharging grooves have a cross sectional shape selected from the group consisting of U-shape, V-shape, rectangular shape and a combination thereof

5. A head cleaning member according to any one of claims 1 to 4, wherein a waste ink sump is further provided so as to collect waste ink that has flown through said ink discharging grooves.

6. A head cleaning member according to any one of claims 1 to 5, wherein said waste ink sump is further provided with an ink absorbent.

7. A head cleaning member according to any one of claims 1 to 6, wherein a side wall which extends in the longitudinal direction and rises up higher than the ridge-like projections defining said ink discharging groove is provided on both ends of said head cleaning member.
